(19) United States
(12) Patent Application Publication
(10) Pub. No.: US 2016/0335357 A1
(43) Pub. Date: Nov. 17, 2016

(54) METHOD AND APPARATUS FOR REDUCING LOAD PEAKS IN USER GROUP MATCHING PROCESS

(71) Applicant: TENCENT TECHNOLOGY (SHENZHEN) COMPANY LIMITED, Shenzhen, Guangdong (CN)

(72) Inventors: Haitao JIANG, Shenzhen (CN); Zheng ZHANG, Shenzhen (CN)

(73) Assignee: TENCENT TECHNOLOGY (SHENZHEN) COMPANY LIMITED, Shenzhen, Guangdong (CN)

(21) Appl. No.: 15/106,053

(22) PCT Filed: Jun. 4, 2015
(86) PCT No.: PCT/CN2015/080749

§ 371 Date: Jun. 17, 2016

(30) Foreign Application Priority Data
Jun. 5, 2014 (CN) 201410248206.6

(51) Int. Cl. G06F 17/30

(52) U.S. Cl. CPC G06F 17/30867; G06F 17/3053

(57) ABSTRACT

A method and apparatus for reducing load peaks in a user group matching process is described. The method may acquire a matching target of a user group (301), and acquire a user set from a maintaining user list according to the matching target (302). The matching target is used for indicating a set of conditions that the user group needs to meet. The method also calculates a matching degree between the user set and the matching target (303), and dynamically judging whether the user set meets the matching target according to the matching degree between the user set and the matching target and a load condition of a server (304). A new user set is reacquired if the user set does not meet the matching target, and the user set is determined as a user group successfully matching if the user set meets the matching target (305).

### FIELD OF THE TECHNOLOGY

The present disclosure relates to server processing technologies, and in particular, to a method and apparatus for reducing load peaks in a user group matching process.

### BACKGROUND OF THE DISCLOSURE

At present, the Internet has become important channels of communication in people's daily life. By means of a variety of applications, people can perform all kinds of social behaviors through the Internet. For example, online games are one kind of applications having social attributes.

A server can gather users having certain generality through a user group matching process, so as to make users look for social objects more conveniently and quickly.

In one scenario of a user group matching process, the server acquires a user set from a waiting queue, and judges whether the user set is in line with a matching target, if yes, the matching is completed, the user set is removed out of the waiting queue, and a matching success processing function is called, and if no, the server continues to acquire a user set. If a user set meeting the matching target cannot be obtained finally, the matching fails.

In view of the above, the main performance of the server is consumed in a cycle of obtaining a user set and authenticating whether the user set meets a matching target. If a user set meeting the matching target cannot be obtained for a long time, the server needs to repeatedly do the work of acquiring a user set and authenticating the matching target. As the time consumed by the process is related to a distribution state of users of the server, time overhead floating is bigger, which is easy to cause high load peaks of the server, thereby reducing performance of the server and prolonging the waiting time of the users.

### SUMMARY

Embodiments of the present invention provide a method and apparatus for reducing load peaks in a user group matching process, which can reduce load peaks of the server, improve the performance of the server and shorten the waiting time of the users.

In one aspect, the embodiments of the present invention provide a method for reducing load peaks in a user group matching process, the method including: acquiring a matching target of a user group, wherein the matching target of the user group is used for indicating a set of conditions that the user group needs to meet; acquiring a user set from a maintaining user list according to the matching target of the user group; calculating a matching degree between the user set and the matching target; dynamically judging whether the user set meets the matching target of the user group according to the matching degree between the user set and the matching target and a load condition of a server; and reacquiring a new user set if the user set does not meet the matching target of the user group, and determining the user set as a user group successfully matching if the user set meets the matching target of the user group.

In another aspect, the embodiments of the present invention further provide an apparatus for reducing load peaks in a user group matching process, including: a matching target acquisition unit, configured to acquire a matching target of a user group, the matching target of the user group being used for indicating a set of conditions that the user group needs to meet; a user set acquisition unit, configured to acquire a user set from a maintaining user list according to the matching target of the user group; a calculation unit, configured to calculate a matching degree between the user set and the matching target; a judgment unit, configured to dynamically judge whether the user set meets the matching target of the user group according to the matching degree between the user set and the matching target and a load condition of a server; the user set acquisition unit being further configured to reacquire a new user set if the user set does not meet the matching target of the user group; and a determination unit, configured to determine the user set as a user group successfully matching if the user set meets the matching target of the user group.

Compared with the existing technology, the embodiment of the present invention can dynamically judge whether the user set meets the matching target of the user group according to a current load condition of a server, so as to reduce load peaks of the server, improve performance of the server and shorten waiting time of users.

### BRIEF DESCRIPTION OF THE DRAWINGS

To describe the technical solutions of the embodiments of the present invention or the existing technology more clearly, the following briefly introduces the accompanying drawings required for describing the embodiments or the existing technology. Apparently, the accompanying drawings in the following description show only some embodiments of the present invention, and a person of ordinary skill in the art may still derive other drawings from these accompanying drawings without creative efforts.

FIG. 1 is a schematic diagram of an application scenario according to one embodiment of the present invention;

FIG. 2 is a hardware structure diagram of a server according to one embodiment of the present invention;

FIG. 3 is a flowchart of a method for reducing load peaks in a user group matching process according to one embodiment of the present invention;

FIG. 4 is a schematic diagram of classification of a matching target according to one embodiment of the present invention;

FIG. 5 is a flowchart of another method for reducing load peaks in a user group matching process according to one embodiment of the present invention;

FIG. 6 is a block diagram of an apparatus for reducing load peaks in a user group matching process according to one embodiment of the present invention;

FIG. 7 is a block diagram of another apparatus for reducing load peaks in a user group matching process according to one embodiment of the present invention; and

FIG. 8 is a block diagram of a further apparatus for reducing load peaks in a user group matching process according to one embodiment of the present invention.

### DESCRIPTION OF EMBODIMENTS

The technical solutions in embodiments of the present invention are clearly and completely described below with reference to the accompanying drawings in the embodiments of the present invention. Apparently, the described embodiments are some of the embodiments of the present invention rather than all of the embodiments. All other embodiments obtained by a person of ordinary skill in the art based on the embodiments of the present invention without creative efforts shall fall within the protection scope of the present disclosure.

This embodiment provides a method and apparatus reducing load peaks in a user group matching process, which can be applied to a server, and the server refers to a device that provides centralized data forwarding and logic processing services for network game clients distributed in different regions.

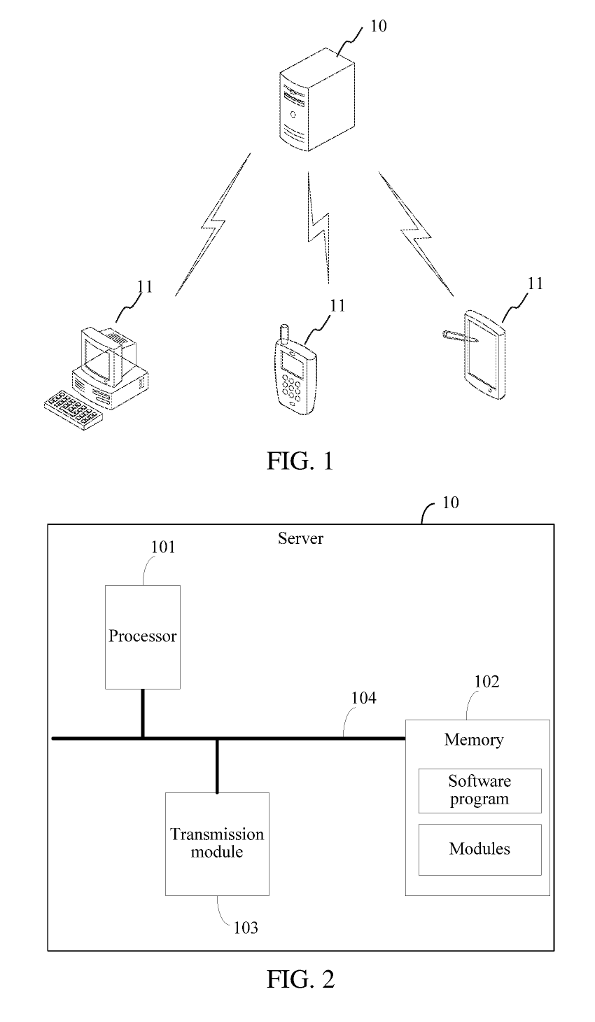

FIG. 1 is a schematic diagram of an application scenario according to one embodiment of the present invention. As shown in FIG. 1, each user 11 can communicate with a server 10 through a network. It can be understood that, although description is given by taking users as an example in FIG. 1, in essence, communication between the user 11 and the server 10 needs to depend on a certain client or a user device. The client or a user device refers to an electronic apparatus installed with an intelligent operating system. A specific example thereof includes, but is not limited to, computers, notebook computers, tablet computers, smart phones, wearable mobile electronic terminals such as smart watches and glasses, and the like.

FIG. 2 is a hardware structure diagram of the server 10. As shown in FIG. 2, the server 10 includes one or more (only one is illustrated in FIG. 2) processors 101, a memory 102, a transmission module 103 and a communication bus 104. A person of ordinary skill in the art can understand that, FIG. 2 merely shows a schematic structure, which does not limit the structure of the server 10. For example, the server 10 may further include more or fewer components than those shown in FIG. 2, or have a configuration different from that shown in FIG. 2.

The communication bus 104 is configured for communication between components of the server 10.

The memory 102 may be configured to store software programs and modules, for example, program instructions/modules corresponding to the method and apparatus for reducing load peaks in a user group matching process in the embodiment of the present invention, and the processor 101 executes different functional applications and performs data processing by running the software programs and modules stored in the memory 102, thereby implementing the method and apparatus for reducing load peaks in a user group matching process. The memory 102 may include a high-speed random memory, and may also include a nonvolatile memory, for example, one or more magnetic storage devices, flash memories or other nonvolatile solid-state memories. In some embodiments, the memory 102 may further include memories remotely disposed relative to the processor 101, and these remote memories may be connected to the server 10 through a network. Examples of the network include but are not limited to, the Internet, an intranet, a local area network, a mobile communications network, or a combination thereof.

The transmission module 103 is configured to receive or send data via a network. Specific examples of the network may include a wired network and a wireless network. In one example, the transmission module 103 includes a Network Interface Controller (NIC), which can be connected with other network devices and a router through cables so as to communicate with the Internet. In one example, the transmission module 103 may be a Radio Frequency (RF) module, configured to wirelessly communicate with a client.

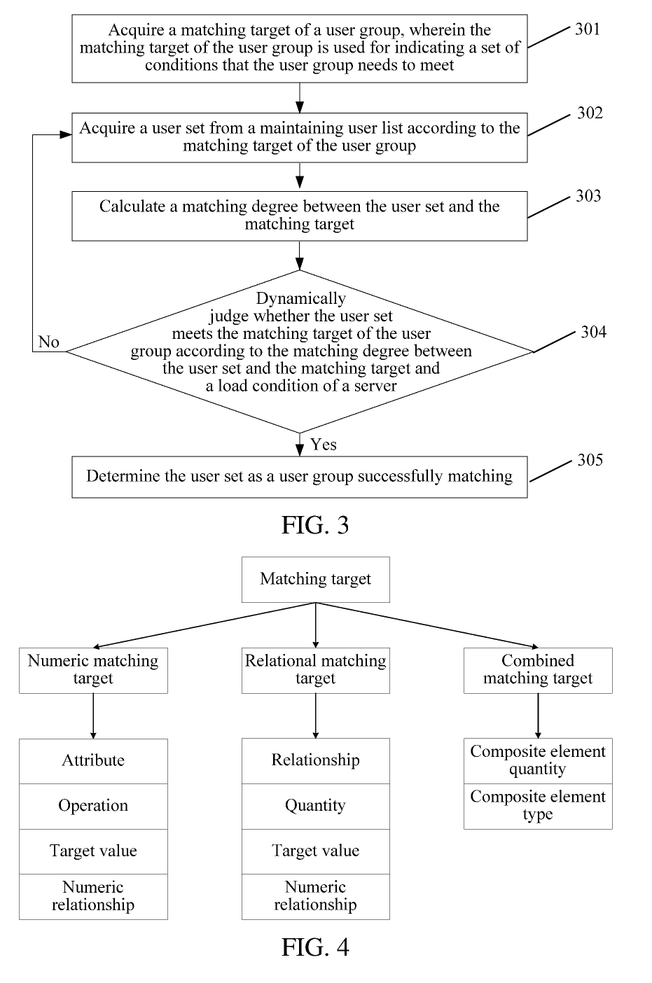

FIG. 3 is a flowchart of a method for reducing load peaks in a user group matching process according to a first embodiment. As shown in FIG. 3, the method includes:

Step 301. Acquire a matching target of a user group, wherein the matching target of the user group is used for indicating a set of conditions that the user group needs to meet.

Exemplarily, the server 10 may initiate a matching behavior under different conditions. For example, referring to FIG. 1, the server 10 may initiate a matching behavior according to a match request sent by a user; or the server may initiate a matching behavior regularly; or the server 10 may trigger matching behavior according to an event. This embodiment does not make specific limitations thereto.

Therefore, in one example, step 301 may include the following steps: receiving a match request sent by a client, the match request corresponding to one or more users and including an ID of a user group where the one or more users make a request for joining; and querying a preset corresponding relationship between IDs of user groups and matching targets according to the ID of the user group, to acquire a matching target corresponding to the ID of the user group.

As shown in FIG. 1, different users initiate match requests to the server 10 respectively. Correspondingly, the server 10 receives the match requests from the users through the transmission module 103. The match requests correspond to at least one user. In one example, each match request merely corresponds to one user. In another example, each match request corresponds to two or more users. For example, a certain user may first invite his/her friends and form a team, and then initiate a match request to the server 10 together. At this time, the match request may correspond to two or more users. After receiving the match request, the server 10 analyzes corresponding users therefrom, and adds each user to a user list. The user list may have a certain logic order, for example, the user list may be sorted according to submission time of the match request. However, it should be understood that a logical sequence thereof may not be consistent with the storage structure and the storage order of the user list.

The match request further includes an ID of a user group where one or more users corresponding to the match request make a request for joining. The client may set an input interface at a terminal device used by the users, an after detecting the ID of the user group on the interface triggered by the users, the client sends a match request of the ID of the user group to the server 10.

The server 10 may preset a corresponding relationship between user groups and matching targets, to acquire a matching target corresponding to the user group by querying the corresponding relationship. It should be understood that one user group may correspond to a plurality of matching targets, and matching processes of the matching targets are the same or similar. The present embodiment only takes that the user group includes one matching target as an example for description.

In another example, step 301 may include the following steps: when a preset time point arrives, querying a corresponding relationship between preset time points and IDs of user groups, to acquire an ID of a user group corresponding to the time point; and querying a preset corresponding relationship between IDs of user groups and matching targets, to acquire a matching target corresponding to the ID of the user group.

In a further example, step 301 may include the following steps: when a preset event occurs, querying a corresponding relationship between preset events and IDs of user groups, to acquire an ID of a user group corresponding to the event; and querying a preset corresponding relationship between IDs of user groups and matching targets, to acquire a matching target corresponding to the ID of the user group.

The matching target refers to a set of conditions that the user group needs to meet. Preferably, the conditions that the user group needs to meet may be disassembled so that one or more conditions are represented with one numeralization information respectively, to cause the matching target of the user group to be modeled. Referring to FIG. 4, the matching target may include three types, which are respectively a numeric matching target, a relational matching target and a combined matching target, and are described below respectively.

1. The numeric matching target is represented with attribute information, operation information, target value information and numeric relationship information.

The attribute information indicates attributes of users, and the attributes may be inherent attributes of the users, for example, strength attributes, intelligence attributes, basic combat effectiveness and the like; or dynamic attributes of the users, for example, locations of the users, the users' additional attributes with timeliness, the users own some items, the users meet a certain condition and the like. The two attributes that the users own some items and the users meet a certain condition can be described through Boolean variables in a program.

The operation information indicates an operation performed on attributers of the users in the user set, for example, the operation may be a sum, an average value, the minimum value of a difference between attributes of any two users, and the like.

The target value is a set attribute target value, and the target value is only allowed to be a numerical value.

The numeric relationship information indicates a relationship with the target value to be met by a result obtained after the operation indicated by the operation information is performed on the attributers of the users. For example, the numeric relationship may be greater than, less than, equal to, greater than or equal to or less than or equal to, etc.

Specifically, the numeric matching target may be described with a four-tuple <attribute, operation, target value, numerical relationship>, for example, the numeric matching target described with <intelligence attribute, average value, 100, greater than or equal to> is: a matching requirement that the user group needs to meet is: average intelligence calculated from intelligence attributes of each user in the user group should be greater than or equal to 100.

2. The relational matching target is represented with relationship information, quantity information, target value information and numeric relationship information.

The relationship information indicates a relationship that the users should meet, and the relationship may be a relationship between various users possibly occurring in games such as a guild relationship and a friendship. It should be noted that, the friendship may be a strict friendship or a loose friendship.

The strict friendship requires that every two users in the user group should be friends. For example, the user group includes 4 users, respectively User 1, User 2, User 3 and User 4, and the strict friendship is formed only when User 1 is in friendship with User 2, User 3 and User 4, User 2 is in friendship with User 1, User 3 and User 4, and User 3 is in friendship with User 1, User 2 and User 4.

The loose friendship means that it is unnecessary that every two users in the user group are friends but may be in indirect friendship, and the indirect friendship means that two users have at least one common user. For example, the user group includes 4 users, respectively User 1, User 2, User 3 and User 4, wherein User 1 and User 2 are friends; User 2 and User 3 are friends; User 3 and User 4 are friends; and then User 1 and User 3 as well as User 4 are in indirect friendship. The 4 users in the user group may form a loose friendship.

The quantity information indicates the number of matching targets meeting a relationship indicated by the relationship information. The target value is a set attribute target value, and the target value is only allowed to be a numerical value.

The numeric relationship information indicates a relationship between the quantity information and the target value. For example, the numeric relationship may be greater than, less than, equal to, greater than or equal to or less than or equal to, etc.

Specifically, the numeric matching target may be described with a four-tuple <relation, quantity, target value, numerical relationship>, for example, the numeric matching target described with <friendship, quantity, 60, greater than or equal to> is: a matching requirement that the user group needs to meet is: in the user group, average intelligence calculated from intelligence attributes of each user should be greater than or equal to 60.

3. The combined matching target is represented with at least one composite element type information and composite element quantity information one-to-one corresponding to the composite element type information.

The composite element type information indicates types of users required by a combined matching target, and the composite element quantity information one-to-one corresponds to the composite element type information. Each pair of composite element quantity information and composite element type information can be described with one sequence of a two-tuple <composite element quantity, composite element type>. The composite element type corresponds to types of responsibilities, and the composite element quantity corresponds to the quantity requirements that the responsibilities should meet in responsibility matching. Such a modeling combined matching target can be achieved conveniently through an array in a program.

For example, a team responsibility match demand common in network games (users for each responsibility in one team should meet a certain quantity requirement) is a common combination relationship. For example, a matching target of a user group (a copy team) consisting of 40 users is: requiring 2 users to assume the responsibility of damage absorption, 8 users to assume the responsibility of healer, and 30 users to assume the responsibility of damage dealer. The matching target may be described as <2, damage absorption><8, healer><30, damage dealer> through a combined matching target mode, which may be achieved through an array with a length of 3 in the program, and elements of the array are {2, 8, 30}.

Step 302. Acquire a user set from a maintaining user list according to the matching target of the user group.

The user set includes at least one user, and the user refers to basic in-game elements configured to construct a user group, including, but not limited to, an in-game role and a Non-Player Character (NPC) that the user plays, various user groups and so on.

In one example, the server 10 may select a user set in sequence in the maintaining user list.

Step 303. Calculate a matching degree between the user set and the matching target.

Exemplarily, step 303 may include the following steps:

303a. Acquire a matching result value of the user set according to the at least one numeralization information of the matching target of the user group.

In one example, step 303a may be implemented through the following steps:

querying a user attribute information database according to the attribute information of the matching target and user IDs in the user set, to acquire an attribute of each user in the user set corresponding to the attribute information, wherein the user attribute information database includes user IDs and at least one attribute corresponding to the user IDs; and

performing an operation indicated by the operation information of the matching target on the attribute of each user in the user set, to obtain the matching result value of the user set.

The server 10 may maintain attribute information of the users, for example, attribute information of each user may be stored in a user attribute information database, and the user attribute information database may be manifested in different forms, which is not limited in the embodiment of the present invention, for example, Table 1 is a user attribute information database in a tabular form.

| | Attribute 1 | Attribute 2 | Attribute 3 |
|---|---|---|---|
| User ID | (intelligence) | (level) | (region) |
| User 1 | 80 | I | Shenzhen |
| User 2 | 60 | III | Beijing |
| User 3 | 100 | II | Shanghai |

As shown in Table 1, the user attribute information database may include user IDs and attributes respectively corresponding to the user IDs. The user IDs may be user names or account numbers that uniquely identify user identity information logged on by users to a client, which is not specifically limited in the embodiment of the present invention.

The server 10, through the user IDs in the user set, can query the user attribute information database, and can acquire user attributes. Then the operation indicated by the operation information of the matching target performed on the attribute of each user in the user set, to obtain a matching result value of the user set. For example, suppose that the numeric matching target is <intelligence attribute, average value, 100, greater than or equal to>, the user set includes 7 users, the server 10 queries the user attribute information database, to acquire intelligence attribute values of each user in the user set, which are supposed to be 80, 60, 100, 120, 80 and 50 respectively, and then an average value of the intelligence attribute values of all the users in the user set is calculated, that is, (80+60+100+120+80+50)/6=70; and the obtained average value 70 is the matching result value of the user set.

In another example, step 303a may be implemented through the following steps: querying a user relationship information database according to the relationship information of the matching target, and in the user set, determining the number of users meeting a relationship indicated by the relationship information, wherein the user relationship information database includes user IDs and relationship information between each two users; and taking the number of users meeting the relationship indicated by the relationship information as the matching result value of the user set.

The server 10 may maintain relationship information of the users, for example, relationship information of each user may be stored in a user relationship information database. The user relationship information database may be manifested in different forms, which is not limited in the embodiment of the present invention. For example, Table 2 is a user relationship information database.

TABLE 2

| | |
|---|---|
| Relationship | |
| (guild) | Member IDs included |

| | | | |
|---|---|---|---|
| Guild 1 | User 1 | User 2 | User 3 |
| Guild 2 | User 4 | User 5 | User 6 |
| Guild 3 | User 8 | User 9 | User 10 |

As shown in Table 2, the user relationship information database may include IDs of each relationship and user IDs included respectively, and the relationship information between every two users may be represented as whether they belong to the same relationship (e.g., a guild).

Table 3 shows a user relationship information database in another form.

TABLE 3

| | |
|---|---|
| User ID | Friend ID |

| | | | |
|---|---|---|---|
| User 1 | User 2 | User 3 | User 4 |
| User 2 | User 4 | User 5 | User 6 |
| User 3 | User 8 | User 9 | User 10 |

As shown in Table 3, the user relationship information database may include each user ID, and user IDs in a particular relationship (e.g., friendship) with each user ID.

The server 10 can query the user relationship information database, in the user set, determines the number of users meeting a relationship indicated by the relationship information, and takes the number of users meeting the relationship indicated by the relationship information as the matching result value of the user set.

For example, suppose that the relational matching target is <friendship, quantity, 60, greater than or equal to>. Suppose that the user set includes 80 users, the server 10 queries the user relationship information database, and determines whether every two users in the 80 users are in friendship. Then the user quantity n meeting the friendship is determined as the matching result value of the user set. In a further example, step 303a may be implemented through the following steps: querying a user responsibility information database according to user IDs in the user set, to acquire a responsibility of each user in the user set, wherein the user responsibility information database includes user IDs and responsibility types corresponding to the user IDs; classifying users in the user set according to responsibilities indicated by each composite element type information of the matching target; and taking a sequence made up of the number of users comprised in each kind of responsibilities as the matching result value of the user set.

The server 10 may maintain user responsibility information, for example, responsibility information of each user may be stored in a user responsibility information database. The user responsibility information database may be manifested in different forms, which is not limited in the embodiment of the present invention. For example, Table 4 is a user responsibility information database.

TABLE 4

| User ID | Responsibility |
|---|---|
| User 1 | damage dealer |
| User 2 | damage absorption |
| User 3 | healer |

Suppose that a combined matching target mode is described as <2, damage absorption><8, healer><30, damage dealer>, it indicates that 2 users are required to assume the responsibility of damage absorption, 8 users to assume the responsibility of healer, and 30 users to assume the responsibility of damage dealer. The matching target may be achieved through an array with a length of 3 in the program, and elements of the array are {2, 8, 30}.

If, in the user set, there are 2 users assuming the responsibility of damage absorption, 7 users assuming the responsibility of healer, and 25 users assuming the responsibility of damage dealer, the user set can be achieved through an array with a length of 3 in the program, elements of the array are {2, 7, 25}, and the matching result value of the user set is {2, 7, 25}.

303b. Compare the matching result value with the matching target of the user group, and calculate the matching degree between the user set and the matching target according to a comparison result.

Exemplarily, the matching degree between the user set and the matching target can be acquired in many computing manners, as long as the manner can reflect the matching degree between the user set and the matching target, which is not limited in the embodiment of the present invention.

In one example, when the matching target is the numeric matching target, or when the matching target is the relational matching target, step 303b may include the following steps: comparing the matching result value of the user set with a target value indicated by the target value information of the matching target; matching a comparison result with a numeric relationship indicated by the numeric relationship information of the matching target; and determining the matching degree between the user set and the matching target of the user group according to a matching result.

For example, suppose that the numeric matching target is <intelligence attribute, average value, 100, greater than or equal to> and the matching result value of the user set is 70, the matching result value 70 of the user set is compared with the target value 100 indicated by the target value information, and the comparison result is less than, which is not in line with the numeric relationship indicated by the numeric relationship information, and the matching degree between the user set and the matching target can be determined according to the comparison result, wherein the matching degree can be represented in a score form, for example, the score of the user set can be calculated through a linear corresponding method, suppose that the full mark is 100, the full mark corresponds to the target value 100, the score of the user set corresponding to the matching result value 70 of the user set is 70, and certainly, this is only exemplary description, and does not make any limitation to the embodiment of the present invention.

In another example, when the matching target is the combined matching target, step 303b may include the following steps: calculating the matching degree between the user set and the matching target based on the number of each kind of responsibilities in the matching result value and the number of composite elements indicated by the composite element quantity information corresponding thereto and according to a preset calculation model.

The preset calculation model may be a weighted sum calculation method, a weighted average calculation method, sum of squares, difference of two squares and many other calculation models, as long as the calculation model can make a calculation result reflect the matching degree between the user set and the matching target, which is not limited in the embodiment of the present invention.

For example, one implementable calculation model is respectively calculating absolute differences of corresponding values in the matching target and the matching result value, and then the absolute differences are added and then averaged.

For example, a combined matching target mode is described as <2, damage absorption><8, healer><30, damage dealer>, and the matching target may be represented as {2, 8, 30}. If the matching result value of the user set is {2, 7, 25}, the score of the user set calculated according to the preset calculation model is [(2-2)+(8-7)+(30-25)]/3=2.

Certainly, the preset calculation model is only exemplarily described, but does not make any limitations to the embodiment of the present invention.

Step 304. Dynamically judge whether the user set meets the matching target of the user group according to the matching degree between the user set and the matching target and a load condition of a server, if no, perform step 302, and if yes, perform step 305.

In one example, step 304 may include the following steps: detecting the load condition of the server; adjusting a dynamic matching degree threshold according to the load condition of the server; determining that the user set does not meet the matching target of the user group if the matching degree is not greater than the dynamic matching degree threshold; and determining that the user set meets the matching target of the user group if the matching degree is greater than the dynamic matching degree threshold.

The adjusting a dynamic matching degree threshold according to the load condition of the server may include: decreasing the dynamic matching degree threshold when load of the server increases; and increasing the dynamic matching degree threshold when the load of the server decreases.

When the load of the server increases, it may be relatively easy to make the matching degree between the user set and the matching target greater than the dynamic matching degree threshold by decreasing the dynamic matching degree threshold, to cause the user set to meet the matching target relatively easily, thereby reducing the time of the whole matching process and reducing the load of the server.

When the load of the server decreases, it may be relatively difficult to make the matching degree between the user set and the matching target greater than the dynamic matching degree threshold by increasing the dynamic matching degree threshold, to cause the user set to meet the matching target relatively difficultly, thereby acquiring the user set that can meet the matching target as much as possible while ensuring the load condition of the server.

Step 305. Determine the user set as a user group successfully matching if the user set meets the matching target of the user group.

The server 10 may call a matching success processing function, for example, users in a user set are transmitted to a designated copy in a copy matching system. Certainly, the server 10 may also send matching success information to the users in the user set through the transmission module 103.

The embodiment of the present invention provides a method for reducing load peaks in a user group matching process, first, a matching target of a user group is acquired; then a user set is acquired from a maintaining user list according to the matching target of the user group; a matching degree between the user set and the matching target is calculated; and finally, whether the user set meets the matching target of the user group is dynamically judged according to the matching degree between the user set and the matching target and a load condition of a server, wherein, a new user set is reacquired if the user set does not meet the matching target of the user group, and the user set is determined as a user group successfully matching if the user set meets the matching target of the user group. Thus, compared with the existing technology, use of the method can dynamically judge whether the user set meets the matching target of the user group according to a current load condition of a server, so as to reduce load peaks of the server, improve performance of the server and shorten waiting time of users.

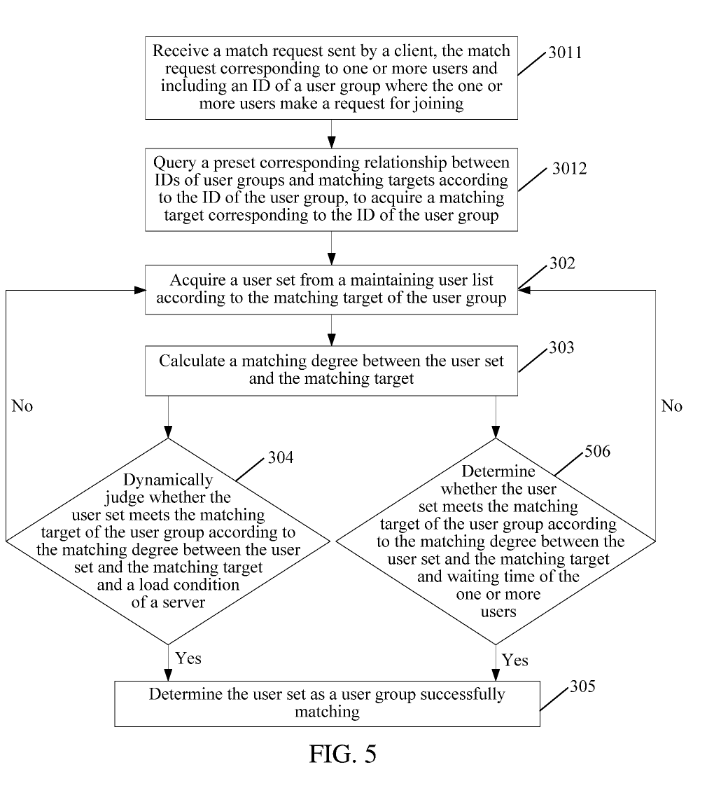

Referring to FIG. 5, FIG. 5 is a flowchart of another method for reducing load peaks in a user group matching process according to a second embodiment. The principle of the second embodiment is the same as that of the first embodiment, and the second embodiment is different from the first embodiment in that, when step 301 is implemented through the following steps, the second embodiment further includes step 506 of determining whether the user set meets the matching target of the user group according to the matching degree between the user set and the matching target and waiting time of the one or more users, if no, performing step 302, and if yes, performing step 305.

3011: Receive a match request sent by a client, the match request corresponding to one or more users and including an ID of a user group where the one or more users make a request for joining.

3012: Query a preset corresponding relationship between IDs of user groups and matching targets according to the ID of the user group, to acquire a matching target corresponding to the ID of the user group.

The one or more users may be one or more users corresponding to the match request sent by the client.

Step 506 may include the following steps: detecting the waiting time of the one or more users; adjusting a dynamic matching degree threshold according to the waiting time of the one or more users; determining that the user set does not meet the matching target of the user group if the matching degree is not greater than the dynamic matching degree threshold; and determining that the user set meets the matching target of the user group if the matching degree is greater than the dynamic matching degree threshold.

The adjusting a dynamic matching degree threshold according to the waiting time of the one or more users may include: decreasing the dynamic matching degree threshold if the waiting time of the one or more users is greater than a preset duration; and increasing the dynamic matching degree threshold if the waiting time of the one or more users is not greater than the preset duration.

If the waiting time of the one or more users is greater than the preset duration, it indicates that the waiting time of the users is too long, in order to improve user experience, it may be relatively easy to make the matching degree between the user set and the matching target greater than the dynamic matching degree threshold by decreasing the dynamic matching degree threshold, to cause the user set to meet the matching target relatively easily, thereby reducing the time of the whole matching process and decreasing the waiting time of the users.

If the waiting time of the one or more users is not greater than the preset duration, it indicates that the waiting time of the users is within a reasonable range, it may be relatively difficult to make the matching degree between the user set and the matching target greater than the dynamic matching degree threshold by increasing the dynamic matching degree threshold, to cause the user set to meet the matching target relatively difficultly, thereby acquiring the user set that can meet the matching target as much as possible while the waiting time of the users is within a reasonable range.

The embodiment of the present invention provides a method for reducing load peaks in a user group matching process, which can dynamically judge whether a user set meets a matching target of a user group according to waiting time of users and shorten the waiting time of the users, thereby reducing load peaks of a server and improving performance of the server.

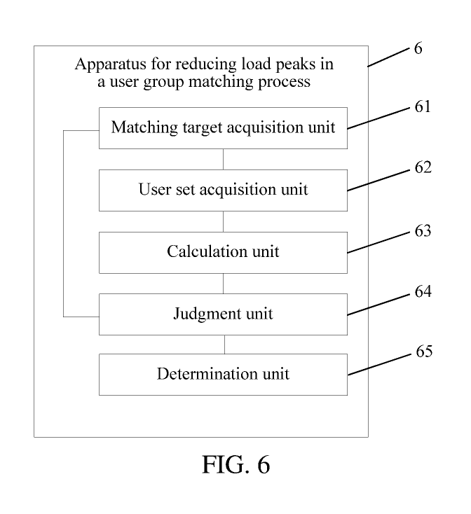

FIG. 6 illustrates an apparatus for reducing load peaks in a user group matching process 6 according to one embodiment of the present invention, which, referring to FIG. 6, including:

a matching target acquisition unit 61, configured to acquire a matching target of a user group, wherein the matching target of the user group is used for indicating a set of conditions that the user group needs to meet;

a user set acquisition unit 62, configured to acquire a user set from a maintaining user list according to the matching target of the user group;

a calculation unit 63, configured to calculate a matching degree between the user set and the matching target;

a judgment unit 64, configured to dynamically judge whether the user set meets the matching target of the user group according to the matching degree between the user set and the matching target and a load condition of a server;

the user set acquisition unit 62 being further configured to reacquire a new user set if the user set does not meet the matching target of the user group; and

a determination unit 65, configured to determine the user set as a user group successfully matching if the user set meets the matching target of the user group.

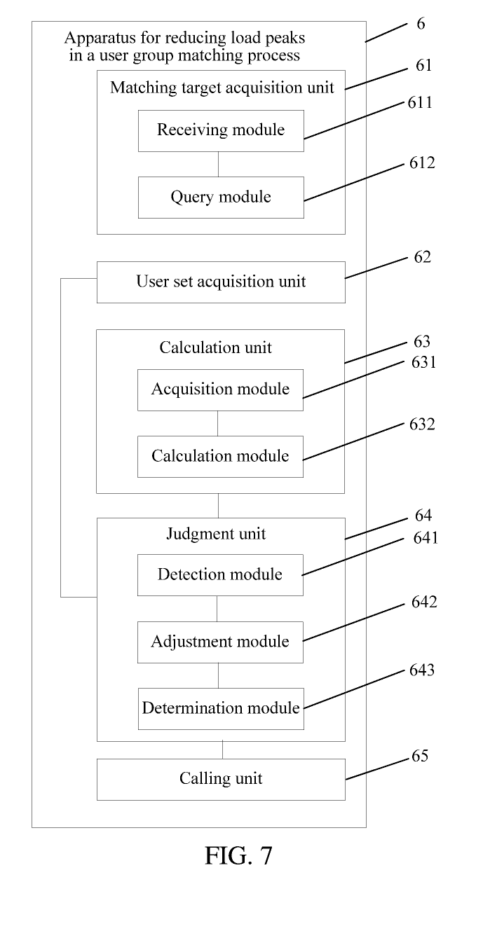

In one example, referring to FIG. 7, the matching target acquisition unit 61 includes:

a receiving module 611, configured to receive a match request sent by a client, the match request corresponding to one or more users and including an ID of a user group where the one or more users make a request for joining; and

a query module 612, configured to query a preset corresponding relationship between IDs of user groups and matching targets according to the ID of the user group, to acquire a matching target corresponding to the ID of the user group.

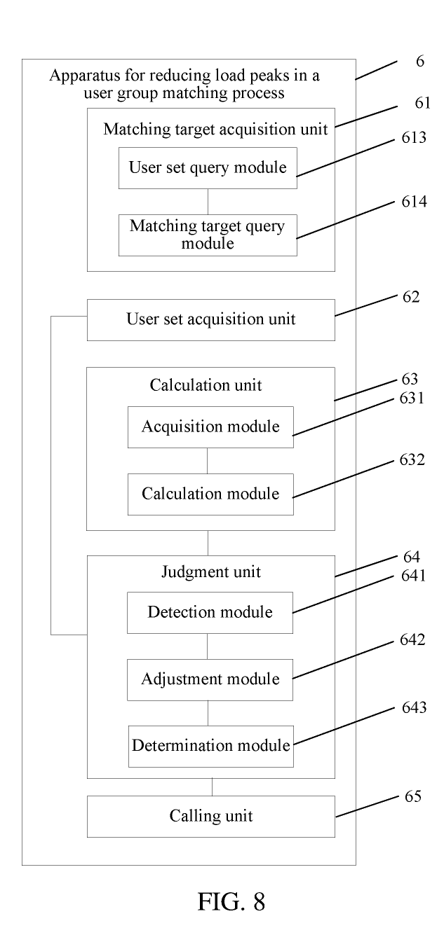

In another example, referring to FIG. 8, the matching target acquisition unit 61 comprises a user group query module 613 and a matching target query module 614, wherein

the user group query module 613 is configured to, when a preset time point arrives, query a corresponding relationship between preset time points and IDs of user groups, to acquire an ID of a user group corresponding to the time point; and

the matching target query module 614 is configured to query a preset corresponding relationship between IDs of user groups and matching targets, to acquire a matching target corresponding to the ID of the user group;

or

the user group query module 613 is configured to, when a preset event occurs, query a corresponding relationship between preset events and IDs of user groups, to acquire an ID of a user group corresponding to the event; and

the matching target query module 614 is configured to query a preset corresponding relationship between IDs of user groups and matching targets, to acquire a matching target corresponding to the ID of the user group.

In one example, referring to FIG. 7 or FIG. 8, the judgment unit 64 includes:

a detection module 641, configured to detect the load condition of the server;

an adjustment module 642, configured to adjust a dynamic matching degree threshold according to the load condition of the server; and

a determination module 643, configured to determine that the user set does not meet the matching target of the user group if the matching degree is not greater than the dynamic matching degree threshold, and determine that the user set meets the matching target of the user group if the matching degree is greater than the dynamic matching degree threshold.

The adjustment module 642 is specifically configured to: decrease the dynamic matching degree threshold when load of the server increases; and increase the dynamic matching degree threshold when the load of the server decreases.

In another example, the judgment unit 64 is further configured to: determine whether the user set meets the matching target of the user group according to the matching degree between the user set and the matching target and waiting time of the one or more users.

The detection module 641 is further configured to detect the waiting time of the one or more users. The adjustment module 642 is further configured to adjust a dynamic matching degree threshold according to the waiting time of the one or more users. The determination module 643 is further configured to determine that the user set does not meet the matching target of the user group if the matching degree is not greater than the dynamic matching degree threshold; and determine that the user set meets the matching target of the user group if the matching degree is greater than the dynamic matching degree threshold.

Further, the adjustment module 642 is further configured to: decrease the dynamic matching degree threshold if the waiting time of the one or more users is greater than a preset duration; and increase the dynamic matching degree threshold if the waiting time of the one or more users is not greater than the preset duration.

Further, the matching target of the user group is represented with at least one numeralization information. Referring to FIG. 7 or FIG. 8, the calculation unit 63 includes an acquisition module 631 and a calculation module 632. The acquisition module 631 is configured to acquire a matching result value of the user set according to the at least one numeralization information of the matching target of the user group. The calculation module 632 compares the matching result value with the matching target of the user group, and calculates the matching degree between the user set and the matching target according to a comparison result.

The matching target may include three types, which are respectively a numeric matching target, a relational matching target and a combined matching target. The numeric matching target is represented with attribute information, operation information, target value information and numeric relationship information. The relational matching target is represented with relationship information, quantity information, target value information and numeric relationship information. The combined matching target is represented with at least one composite element type information and composite element quantity information one-to-one corresponding to the composite element type information.

In one example, when the matching target of the user group is the numeric matching target, the acquisition module 631 is configured to: query a user attribute information database according to the attribute information of the matching target and user IDs in the user set, to acquire an attribute of each user in the user set corresponding to the attribute information, wherein the user attribute information database includes user IDs and at least one attribute corresponding to the user IDs; and perform an operation indicated by the operation information of the matching target on the attribute of each user in the user set, to obtain the matching result value of the user set.

In another example, when the matching target of the user group is the relational matching target, the acquisition module 631 is configured to: query a user relationship information database according to the relationship information of the matching target, and in the user set, determine the number of users meeting a relationship indicated by the relationship information, wherein the user relationship information database includes user IDs and relationship information between each two users; and take the number of users meeting the relationship indicated by the relationship information as the matching result value of the user set.

In a further example, when the matching target of the user group is the combined matching target, the acquisition module 631 may query a user responsibility information database according to user IDs in the user set, to acquire a responsibility of each user in the user set, wherein the user responsibility information database comprises user IDs and responsibility types corresponding to the user IDs, classify users in the user set according to responsibilities indicated by each composite element type information of the matching target, and take a sequence made up of the number of users comprised in each kind of responsibilities as the matching result value of the user set.

In one example, when the matching target of the user group is the numeric matching target or the relational matching target, the calculation module 632 may compare the matching result value of the user set with a target value indicated by the target value information of the matching target, match a comparison result with a numeric relationship indicated by the numeric relationship information of the matching target, and determine the matching degree between the user set and the matching target of the user group according to a matching result.

In another example, when the matching target of the user group is the combined matching target, the calculation module 632 calculates the matching degree between the user set and the matching target based on the number of each kind of responsibilities in the matching result value and the number of composite elements indicated by the composite element quantity information corresponding thereto and according to a preset calculation model.

The embodiment of the present invention provides an apparatus for reducing load peaks in a user group matching process 6, which first acquires a matching target of a user group; then acquires a user set from a maintaining user list according to the matching target of the user group; calculates a matching degree between the user set and the matching target d; and finally, dynamically judges whether the user set meets the matching target of the user group according to the matching degree between the user set and the matching target and a load condition of a server, wherein, a new user set is reacquired if the user set does not meet the matching target of the user group, and the user set is determined as a user group successfully matching if the user set meets the matching target of the user group. Thus, compared with the existing technology, use of the method can dynamically judge whether the user set meets the matching target of the user group according to a current load condition of a server, so as to reduce load peaks of the server, improve performance of the server and shorten waiting time of users.

In the embodiments provided in the present application, it should be understood that the system, apparatus and method disclosed herein can be implemented in other manners. For example, the apparatus embodiments described above are merely schematic, for example, division of the units is merely logical function division, there may be other division manners during actual implementation, for example, a plurality of units or components can be combined or integrated to another system, or some features can be omitted or not performed. Another point is that, mutual coupling or direct coupling or communication connections displayed or discussed may be indirect coupling or communication connections through some interfaces, apparatuses or units, and may be electrical, mechanical, or other forms.

The units described as separate parts may be or may not be physically separated, the parts displayed as units may be or may not be physical units, that is, they may be located in one place or may be distributed on a plurality of network units. Some or all of the units may be selected according to actual requirements to achieve the objective of the solution of the embodiment.

In addition, the functional modules in the embodiments of the present invention may be integrated into one processing unit, or each of the modules may be included alone physically, or two or more modules may be integrated into one unit. The integrated unit may be implemented in the form of hardware, or may be implemented in the form of a software functional unit.

The integrated units implemented in the form of a software functional unit may be stored in a storage medium and includes several instructions for enabling a computer device (which may be a personal computer, a server, a network device, or the like) to execute all or some of the steps of the method in the embodiments of the present application. The foregoing storage medium includes a USB flash drive, a removable hard disk, a read-only memory (ROM), a random access memory (RAM), a magnetic disk or an optical disk, or any other mediums that can store program codes.

The above are merely specific implementations of the present disclosure, but the protection scope of the present disclosure is not limited thereto. Variations or replacements that any person skilled in the art can easily think of within the technical scope of the present disclosure should be covered by the protection scope of the present disclosure. Therefore, the protection scope of the present disclosure should be subject to the protection scope of the claims.

1. A method for reducing load peaks in a user group matching process, the method comprising:
acquiring a matching target of a user group, the matching target of the user group being used for indicating a set of conditions that the user group needs to meet;
acquiring a user set from a maintaining user list according to the matching target of the user group;
calculating a matching degree between the user set and the matching target;
dynamically judging whether the user set meets the matching target of the user group according to the matching degree between the user set and the matching target and a load condition of a server; and
reacquiring a new user set if the user set does not meet the matching target of the user group, and determining the user set as a user group successfully matching if the user set meets the matching target of the user group.

2. The method according to claim 1, wherein
the acquiring a matching target of a user group comprises:
receiving a match request sent by a client, the match request corresponding to one or more users and comprising an ID of a user group where the one or more users make a request for joining; and
querying a preset corresponding relationship between IDs of user groups and matching targets according to the ID of the user group, to acquire a matching target corresponding to the ID of the user group.

3. The method according to claim 1, wherein the acquiring a matching target of a user group comprises:
when a preset time point arrives, querying a corresponding relationship between preset time points and IDs of user groups, to acquire an ID of a user group corresponding to the time point; and
querying a preset corresponding relationship between IDs of user groups and matching targets, to acquire a matching target corresponding to the ID of the user group.

4. The method according to claim 1, wherein the acquiring a matching target of a user group comprises:
when a preset event occurs, querying a corresponding relationship between preset events and IDs of user groups, to acquire an ID of a user group corresponding to the event; and
querying a preset corresponding relationship between IDs of user groups and matching targets, to acquire a matching target corresponding to the ID of the user group.

5. The method according to claim 1, wherein the dynamically judging whether the user set meets the matching target of the user group according to the matching degree between the user set and the matching target and a load condition of a server comprises:
detecting the load condition of the server;
adjusting a dynamic matching degree threshold according to the load condition of the server.

6. The method according to claim 5, further comprising:
determining that the user set does not meet the matching target of the user group if the matching degree is not greater than the dynamic matching degree threshold; and
determining that the user set meets the matching target of the user group if the matching degree is greater than the dynamic matching degree threshold.

7. The method according to claim 5, wherein the adjusting a dynamic matching degree threshold according to the load condition of the server comprises:
decreasing the dynamic matching degree threshold when load of the server increases; and
increasing the dynamic matching degree threshold when the load of the server decreases.

8. The method according to claim 2, wherein the method further comprises: determining whether the user set meets the matching target of the user group according to the matching degree between the user set and the matching target and waiting time of the one or more users.

9. The method according to claim 8, wherein the determining whether the user set meets the matching target of the user group according to the matching degree between the user set and the matching target and waiting time of the one or more users comprises:
detecting the waiting time of the one or more users;
adjusting a dynamic matching degree threshold according to the waiting time of the one or more users.

10. The method according to claim 9, further comprising:
determining that the user set does not meet the matching target of the user group if the matching degree is not greater than the dynamic matching degree threshold; and
determining that the user set meets the matching target of the user group if the matching degree is greater than the dynamic matching degree threshold.

11. The method according to claim 9, wherein the adjusting a dynamic matching degree threshold according to the waiting time of the one or more users comprises:
decreasing the dynamic matching degree threshold if the waiting time of the one or more users is greater than a preset duration; and
increasing the dynamic matching degree threshold if the waiting time of the one or more users is not greater than the preset duration.

12. The method according to claim 1, wherein the matching target is represented with at least one numeralization information, and the calculating a matching degree between the user set and the matching target comprises:
acquiring a matching result value of the user set according to the at least one numeralization information of the matching target of the user group; and
comparing the matching result value with the matching target of the user group, and calculating the matching degree between the user set and the matching target according to a comparison result.

13. The method according to claim 12, wherein the matching target comprises three types, which are respectively a numeric matching target, a relational matching target and a combined matching target; wherein
the numeric matching target is represented with attribute information, operation information, target value information and numeric relationship information;
the relational matching target is represented with relationship information, quantity information, target value information and numeric relationship information; and
the combined matching target is represented with at least one composite element type information and composite element quantity information one-to-one corresponding to the composite element type information.

14. The method according to claim 13, wherein, when the matching target of the user group is the numeric matching target, the acquiring a matching result value of the user set according to the at least one numeralization information of the matching target of the user group comprises:
querying a user attribute information database according to the attribute information of the matching target and user IDs in the user set, to acquire an attribute of each user in the user set corresponding to the attribute information, wherein the user attribute information database comprises user IDs and at least one attribute corresponding to the user IDs; and
performing an operation indicated by the operation information of the matching target on the attribute of each user in the user set, to obtain the matching result value of the user set.

15. The method according to claim 13, wherein, when the matching target of the user group is the relational matching target, the acquiring a matching result value of the user set according to the at least one numeralization information of the matching target of the user group comprises:
querying a user relationship information database according to the relationship information of the matching target, and in the user set, determining the number of users meeting a relationship indicated by the relationship information, wherein the user relationship information database comprises user IDs and relationship information between each two users; and
taking the number of users meeting the relationship indicated by the relationship information as the matching result value of the user set.

16. (canceled)

17. The method according to claim 13, wherein, when the matching target of the user group is the combined matching target, the acquiring a matching result value of the user set according to the at least one numeralization information of the matching target of the user group comprises:
querying a user responsibility information database according to user IDs in the user set, to acquire a responsibility of each user in the user set, wherein the user responsibility information database comprises user IDs and responsibility types corresponding to the user IDs;
classifying users in the user set according to responsibilities indicated by each composite element type information of the matching target; and
taking a sequence made up of the number of users comprised in each kind of responsibilities as the matching result value of the user set.

18. (canceled)

19. An apparatus for reducing load peaks in a user group matching process, comprising:
a matching target acquisition unit, configured to acquire a matching target of a user group, the matching target of the user group being used for indicating a set of conditions that the user group needs to meet;
a user set acquisition unit, configured to acquire a user set from a maintaining user list according to the matching target of the user group;
a calculation unit, configured to calculate a matching degree between the user set and the matching target;
a judgment unit, configured to dynamically judge whether the user set meets the matching target of the user group according to the matching degree between the user set and the matching target and a load condition of a server;
the user set acquisition unit being further configured to reacquire a new user set if the user set does not meet the matching target of the user group; and
a determination unit, configured to determine the user set as a user group successfully matching if the user set meets the matching target of the user group.

20. The apparatus according to claim 19, wherein
the matching target acquisition unit comprises:
a receiving module, configured to receive a match request sent by a client, the match request corresponding to one or more users and comprising an ID of a user group where the one or more users make a request for joining; and
a query module, configured to query a preset corresponding relationship between IDs of user groups and matching targets according to the ID of the user group, to acquire a matching target corresponding to the ID of the user group.

21. The apparatus according to claim 19, wherein the matching target acquisition unit comprises:
a user group query module is configured to, when a preset time point arrives, query a corresponding relationship between preset time points and IDs of user groups, to acquire an ID of a user group corresponding to the time point; and
a matching target query module is configured to query a preset corresponding relationship between IDs of user groups and matching targets, to acquire a matching target corresponding to the ID of the user group.

22. (canceled)

23. The apparatus according to claim 19, wherein the judgment unit comprises:
a detection module, configured to detect the load condition of the server;
an adjustment module, configured to adjust a dynamic matching degree threshold according to the load condition of the server; and
a determination module, configured to determine that the user set does not meet the matching target of the user group if the matching degree is not greater than the dynamic matching degree threshold, and determine that the user set meets the matching target of the user group if the matching degree is greater than the dynamic matching degree threshold.

24. (canceled)

25. (canceled)

26. (canceled)
